(19) United States
(12) Patent Application Publication
(10) Pub. No.: US 2006/0246002 A1
(43) Pub. Date: Nov. 2, 2006

(54) Offretite aluminosilicate composition and preparation and use of same

(75) Inventors: Andres M. Quesada Perez, Caracas (VE); Gerardo Vitale-Rojas, Los Teques (VE)

Correspondence Address: BACHMAN & LAPOINTE, P.C., 900 CHAPEL STREET, SUITE 1201, NEW HAVEN, CT, 06510, US

(73) Assignee: Intevep, S.A.

(21) Appl. No.: 11/119,015

(22) Filed: Apr. 29, 2005

(51) Int. Cl. C01B 39/00; B01J 29/00

(52) U.S. Cl. 423/713; 423/718; 502/60; 502/74

(57) ABSTRACT

An offretite metalloalluminosilicate composition, including an aluminosilicate framework containing at least one metal selected from the group consisting of iron, divalent elements and combinations thereof, wherein at least a portion of the metal is incorporated into the framework, and wherein the portion is at least about 0.5% wt. with respect to the composition.

### BACKGROUND OF THE INVENTION

1. Field of the Invention

This invention relates to a novel synthetic crystalline aluminosilicate composition of offretite (OFF) topology, designated as IPZ-D, a method to obtain such material and its combination with other chemical elements like iron, zinc, nickel and mixtures thereof. The invention further relates to the use of the materials in processes of catalytic conversion of hydrocarbons and/or as a sorbent.

2. Description of Related Art

Zeolites are crystalline aluminosilicates having as a fundamental unit a tetrahedral complex consisting of Si⁴⁺ and Al³⁺ in tetrahedral coordination with four oxygen atoms. Shared oxygen atoms link those tetrahedral units of [SiO4] and [Alo4] to each other and in this way they form three-dimensional networks. The building of such networks produces channels and cavities of molecular dimensions. Water molecules and charged compensating cations are found inside the channels and cavities of the zeolitic networks.

Even though there was much knowledge about zeolites and their catalytic and adsorptive properties, it was not until the middle of the last century that commercial preparation and use of zeolites was possible. This advance allowed more research into the synthesis and modification of zeolitic materials producing a large number of new structures and materials

The incorporation into the synthesis gel of other compounds (organic and/or inorganic) to produce zeolitic molecular sieves allowed an important advance in this area of research. This variation not only has modified the physical-chemical properties of the zeolitic materials of known structures, but also has given rise to the production of new structures unknown in the aluminosilicate frameworks.

Offretite is a rare natural zeolite. The structure can be described by a sequence AABAAB . . . of 6-membered rings of tetrahedra. The International Zeolite Association (IZA) has assigned the three-letter code OFF to materials that have the same framework type as the natural zeolite offretite.

Researchers have been able to produce synthetic samples with the OFF framework type. Some of these synthetic samples are “contaminated” with another zeolite called Erionite (ERI topology), and this contamination changes the molecular sieve properties of the zeolite with the OFF framework because the 12-ring channel of the OFF framework is partially blocked. This type of product is called Offretite/Erionite intergrowth and it has different physical-chemical properties than the OFF and ERI type framework materials individually. An example of this type of material is ZSM-34 (U.S. Pat. No. 4,086,186). The intergrowth is observed in the x-ray diffraction pattern of the material by the presence of additional lines observed at about 9.6, 16.6, 21.4 and 31.9 2-Theta (Bragg angle).

There are a great number of patents related to offretite and offretite/erionite aluminosilicate materials, for instance, U.S. Pat. No. 6,019,956, U.S. Pat. No. 5,534,239, U.S. Pat. No. 5,008,000, U.S. Pat. No. 4,992,400, U.S. Pat. No. 4,093,699, U.S. Pat. No. 4,339,353, U.S. Pat. No. 4,528,410, U.S. Pat. No. 4,687,653, U.S. Pat. No. 4,086,186, U.S. Pat. No. 3,578,398, EP0190949, EP0400961 and EP0753482. These patents are related to the preparation of aluminosilicate materials of offretite or offretitie/erionite type. They include methodologies to prepare large crystals, small crystals, colloidal crystals, short time preparations, and post-synthesis methods to increase the silicon to aluminum ratio of the materials.

Another group of patents is related to impregnation or ion-exchange of aluminosilicate materials of the offretite type with metals from the periodic table group IB to VIII, for instance, U.S. Pat. No. 4,259,174, U.S. Pat. No. 4,497,703, U.S. Pat. No. 4,116,813, U.S. Pat. No. 4,086,186, U.S. Pat. No. 5,616,170 and U.S. Pat. No. 5,041,272. For those cases, impregnation or ion-exchange incorporates a third element (besides silicon and aluminum), and this third element is not a part of the aluminosilicate framework structure.

There is a third group of patents in which a third element is incorporated intentionally within the synthesis gel and this third element is incorporated within the framework structure, and the product of this type of synthesis can be called metaloaluminosilicates of OFF topology. Examples of this type of material are given in the following patents: WO09214680, U.S. Pat. No. 5,756,064, U.S. Pat. No. 4,994,254, and U.S. Pat. No. 5,133,951. The synthesis procedures of the patents WO09214680 and U.S. Pat. No. 5,756,064 incorporate small traces (between 15 and 900 ppm) of magnesium, barium or cobalt into the synthesis gel to produce small crystals of offretite materials in which those elements are incorporated within the resulting materials. U.S. Pat. No. 4,994,254 describes the incorporation of gallium into the synthesis gel to produce a gallioaluminosilicate material of OFF topology in which gallium can replace half of the aluminum of the aluminosilicate framework. This modification will produce a substantially different material, which in turn will behave differently as a catalyst or sorbent than a normal aluminosilicate material with the same OFF topology. U.S. Pat. No. 5,133,951 describes the preparation of a pure galliosilicate material with OFF topology in which all the aluminum is replaced with gallium and of course this material behaves differently than an aluminosilicate when used as catalyst or sorbent.

Despite the foregoing teachings, the need remains for additional types of structures which can be synthesized to provide desired offretite topology aluminosilicate materials.

It is therefore the primary object of the present invention to provide such materials.

It is a further object of the invention to provide a method for preparation of such materials.

It is another object in the present invention to provide processes for use of such materials in catalytic conversion of organic compounds, or as sorbent.

Other objects and advantages of the present invention will appear hereinbelow.

### SUMMARY OF THE INVENTION

The crystalline aluminosilicate composition of the present invention can be seen as metaloaluminosilicate materials in which iron, zinc, nickel, or mixtures thereof are added in great quantities into the synthesis gel to produce the desired material having more than 0.5 wt % of the elements as a part of the material, i.e. in the framework of the material. The additional elements are not ion-exchangeable by conventional methods.

The invention presents a new family of crystalline metaloaluminosilicate materials of OFF topology, designated as IPZ-D, and the methodology to obtain such materials, and their use in the fluid catalytic conversion area. The synthetic metaloaluminosilicates produced with the present method have physical and chemical characteristics which make them clearly distinguishable from other products with OFF topology. The preparation method developed in accordance with the invention allows incorporation in the synthesis gel of other elements of the periodic table. They are able to interact with the source of silicon and aluminum in a strong basic medium without the need of complexing agents. In this way, the elements are incorporated in the material prepared and those elements are not ion-exchangeable when the final material is obtained. The elements that can be incorporated into the aluminosilicate framework of the present invention are iron, and/or divalent element, preferably zinc and/or nickel, and mixtures thereof. The amount of such elements present in the aluminosilicate material of the present invention may vary depending on the required amount of such element (or elements) in the material and desired end use of same. However, the total amount of elements added is above 0.5 wt % with respect to the total composition weight.

It is possible to mix more than two elements in a given material of the present invention as may be desired. However, for all compositions of the present invention, it is critical that the incorporated elements (iron, and/or divalent elements) which are not ion-exchangeable by conventional techniques be present in the aluminosilcate material in total quantities greater than or equal to 0.5 wt %. The new materials show X-ray diffraction patterns which contain certain definable minimum lattice distances. The X-ray diffraction pattern includes values substantially as set forth in Table 1 of the specification. Furthermore, the new metaloaluminosilicate materials show specific absorption bands in the infrared spectrum.

The novel material has a composition having a molar relationship as follows:
SiO_{2:m Al}₂O_{3:n Fe}₂O_{3:o ZO}
Wherein Z is a divalent element, preferably zinc, nickel or a mixture thereof, wherein m is from 0.02 to 0.5, n is from 0 to 0.5, and o is from 0 to 0.5, and wherein n+o is greater than 0.

The invention further resides in a method for the preparation of IPZ-D, and the conversion of organic compounds such as hydrocarbons with an active form of the material.

### BRIEF DESCRIPTION OF THE DRAWINGS

A detailed description of preferred embodiments of the present invention follows, with reference to attached drawings, wherein:

FIG. 1 is an X-ray diffraction pattern of the as-synthesized product of Sample 1.

FIG. 2 is an X-ray diffraction pattern of the as-synthesized product of Sample 2.

FIG. 3 is an X-ray diffraction pattern of the ion-exchanged and calcined product of Sample 2.

FIG. 4 is an X-ray diffraction pattern of the as-synthesized product of Sample 3.

FIG. 5 is an X-ray diffraction pattern of the calcined product of Sample 3.

FIG. 6 is an X-ray diffraction pattern of the as-synthesized product of Sample 4.

FIG. 7 is an X-ray diffraction pattern of as-synthesized product of Sample 5.

FIG. 8 is an X-ray diffraction pattern of the as-synthesized product of Sample 6.

FIG. 9 is an X-ray diffraction pattern of the as-synthesized product of Sample 7.

FIG. 10 is an X-ray diffraction pattern of the as-synthesized product of Sample 8.

FIG. 11 is an Infrared Spectrum of the as-synthesized product of Sample 6.

FIG. 12 is an Infrared spectrum of the as-synthesized product of Sample 9.

### DETAILED DESCRIPTION

The invention relates to a new family of crystalline mataloaluminosilicate materials of offretite (OFF) topology, designated as IPZ-D, and a method to obtain such materials, as well as use of such materials, preferably in the FCC field. The synthetic metaloaluminosilicates produced with the present method have physical and chemical characteristics which make them clearly distinguishable from other products with OFF topology.

The preparation method developed in accordance with the invention allows incorporation in the synthesis gel of other elements of the periodic table. These elements are able to interact with the source of silicon and aluminum in a strong basic medium without the need of complexing agents. In this way, the elements are incorporated in the material prepared, that is, into the framework of the material, and those elements are not ion-exchangeable when the final material is obtained. The elements that can be incorporated into the aluminosilicate framework of the present invention are iron and a divalent element, preferably zinc, nickel, and mixtures thereof. The amount of such elements present in the aluminosilicate framework of the present invention may vary depending on the required amount of such element (or elements) in the material, however, the total amount or portion of elements added and incorporated into the framework is advantageously at least about 0.5 wt % based upon weight of the composition, and this portion preferably represents at least a majority of total elements added. More than two of these elements can be mixed in a given material of the present invention according to process.

However, for all compositions of the present invention, it is essential that the total weight of framework incorporated elements, that portion which is not ion-exchangeable by conventional techniques, be present in the aluminosilicate material in total quantities equal to or greater than about 0.5 wt %.

The new material shows X-ray diffraction patterns which contain certain definable minimum lattice distances. The X-ray diffraction pattern includes values substantially as set forth in Table 1 set forth below.

TABLE 1

| Interplanar d-Spacing (Å) | Relative Intensity |
|---|---|
| 11.44 ± 0.40 | S |
| 7.54 ± 0.10 | W |
| 6.61 ± 0.10 | M |
| 6.30 ± 0.10 | W |
| 5.73 ± 0.08 | VW |
| 4.56 ± 0.08 | VW |
| 4.33 ± 0.08 | M |
| 3.83 ± 0.08 | W |
| 3.76 ± 0.06 | VS |
| 3.58 ± 0.06 | S |
| 3.41 ± 0.06 | VW |
| 3.31 ± 0.06 | W |
| 3.15 ± 0.06 | M |
| 2.93 ± 0.05 | VW |
| 2.85 ± 0.05 | VS |
| 2.68 ± 0.05 | W |
| 2.48 ± 0.05 | VW |
| 2.35 ± 0.05 | VW |
| 2.29 ± 0.05 | VW |
| 2.21 ± 0.05 | VW |
| 2.12 ± 0.05 | VW |
| 1.98 ± 0.03 | VW |
| 1.96 ± 0.03 | VW |
| 1.89 ± 0.03 | VW |
| 1.86 ± 0.03 | VW |
| 1.83 ± 0.03 | VW |
| 1.77 ± 0.02 | VW |
| 1.69 ± 0.02 | VW |
| 1.66 ± 0.02 | VW |
| 1.58 ± 0.02 | VW |

wherein VS = very strong, S = strong, M = middle, W = weak, and VW = very weak.

Furthermore, the new metaloaluminosilicate materials show specific absorption bands in the infrared spectrum.

The novel material has a composition having a molar relationship as follows:
SiO_{2:m Al}₂O_{3:n Fe}₂O_{3:o ZO.}

Wherein Z is a divalent element such as zinc, nickel, or a mixture thereof, and wherein m is from 0.02 to 0.5, preferably from 0.05 to 0.5, n is from 0 to 0.5, o is from 0 to 0.5, and n+o>0.

The metaloaluminosilicate of the present invention can be synthesized with the methodology of the present invention without the presence of organic templates. It has been found that if care is not taken, a contamination with a different zeolitic phase, phillipsite (PHI topology) may occur. To avoid the possible presence of phillipsite for practical convenience, a small amount of tetramethylammonium ions (TMA⁺) can be added.

In the as-synthesized form, the metaloaluminosilicate material has a chemical formula, on an anhydrous basis and in terms of mole ratio of oxides as follows:
a (K+Na)₂O:b R₂O:SiO₂:m Al₂O_{3:n Fe}₂O_{3:o ZO}

In their ratio, R is an organic moiety of the tetraalkylammonium family, preferably tetramethylammonium (TMA⁺), a is from 0.01 to 0.2, b is from 0 to 0.15, and M, n and o are as set forth above. The Na, K, and R components are associated with the material as a result of their presence in the crystallization gel, and are easily removed by post-crystallization methods hereinafter more particularly described.

The crystalline material of the present invention can be synthesized without the presence of the divalent element (zinc and/or nickel) in which case the chemical formula, on an anhydrous basis and in terms of mole ratio of oxides, is the following:
a (K+Na)₂O:b R₂O:SiO₂:m Al₂O_{3:n Fe}₂O₃.

The crystalline material of the present invention can also be synthesized without the presence of iron in which case the chemical formula, on an anhydrous basis and in term of mole ratio of oxides is the following:
a (K+Na)₂O:b R₂O:SiO₂:m Al₂O₃:o ZO.

The novel crystalline material of the present invention is thermally stable and exhibits textural properties which make it suitable for use in processes of catalytic conversion of organic compounds and or as sorbent.

Part of the original alkaline cation of the as-synthesized material (potassium and/or sodium) can be replaced in accordance with techniques well known in the art, by ion exchange with other types of cations. The preferred replacing cations include metal ions, hydrogen ions, hydrogen precursor ions (ammonium ion, for instance), and mixtures thereof. The cations preferred for ion exchange are those which tailor the desired catalytic activity for certain hydrocarbon conversion reactions. These include hydrogen, rare earth metals and metals of the periodic table groups IB, IIB, IIIB, IVB, IIA, IIIA, IVA, and VIII.

The novel crystalline metaloaluminosilicate materials of the present invention have an X-ray diffraction pattern with the OFF framework type as listed in Table 1. In the event that the material contains phillipsite zeolitic material, this non-wanted material can be destroyed and removed by a simple thermal treatment of the mixture, in which case the lines of the X-ray diffraction pattern of the thermally treated material are similar to those presented in Table 1.

A Phillips diffractometer was employed to obtain X-ray diffraction data presented in Table 1 above, using cooper K-alpha radiation. The conditions for acquisition of the data were as follows: a step scanning of 0.05 degrees of two-theta (theta is the Bragg angle), and a counting time of 1 second for each step. The units of the interplanar spacings, d's, were calculated in Angstroms (Å). The relative intensity of each line (I/Iₒ) is one-hundredth of the intensity of the strongest line, above the background. These were derived using a commercially available profile fitting routine, which was provided with the equipment software. The intensities reported are uncorrected for Lorentz and polarization effects.

When the material of the present invention is prepared without the use of TMA⁺ ions, there is no need for calcination prior to ion exchange of the resulting material. This is true even when phillipsite is present.

When the material has been prepared with a small amount of TMA⁺, preferably the as-synthesized material is calcined to remove all or part of the organic template before ion exchange. This thermal treatment is generally performed by heating at a temperature of at least about 450° C. for at least 1 minute and generally no longer than 24 hours. For convenience, atmospheric pressure is desired for the thermal treatment. The thermal treatment can be performed at a temperature up to about 1000° C. When phillipsite is present, the same thermal treatment employed to obtain the active form of the material is enough to destroy this additional phase.

The novel crystalline materials of the present invention have useful properties including catalytic activity. These novel crystalline compositions may advantageously be employed in existing processes which presently use aluminosilicate zeolites. The novel crystalline compositions of the present invention may advantageously be incorporated with binders, clays, aluminas, silicas, or other materials, which are well known in the art. They also can be modified with one or more elements or compounds by deposition, occlusion, ion-exchange or other techniques known to those skilled in the art to enhance, supplement or alter the properties or usefulness of the crystalline compositions of the present invention. The crystalline compositions of the present invention can be used as additives or catalysts in the FCC area.

The crystalline materials of the present invention can be prepared from a reaction mixture containing a source of silicon, a source of alkali ions, for example sodium and potassium, a source of trivalent element such as aluminum, iron, or mixtures thereof, a source of divalent elements such as zinc, nickel, or mixtures thereof, a source of organic template, when needed such as tetralakylammonium ions, preferably tetramethylammonium ion (TMA⁺), and water. The reaction mixture is preferably prepared having a composition, in terms of mole ratios of oxides, within the ranges shown in Table 2.

TABLE 2

| Mole Ratio of Reactants | Broad range | Preferred range |
|---|---|---|
| Al₂O₃/SiO₂ | 0.01 to 0.5 | 0.02 to 0.25 |
| Fe₂O₃/SiO₂ | 0 to 0.5 | 0.01 to 0.25 |
| ZO/SiO₂ | 0 to 0.5 | 0 to 0.5 |
| (K + Na)₂O/SiO₂ | 0.1 to 2 | 0.2 to 0.8 |
| R/SiO₂ | 0 to 1 | 0 to 0.3 |
| H₂O/SiO₂ | 1 to 100 | 5 to 30 |

Preferred sources of SiO₂ include colloidal silica, sodium silicate, sodium metasilicate, fume silicate, silicon oxide and/or clays, preferably sodium silicate. The preferred sources of ZO include soluble salts, hydroxides and/or oxides of zinc, and/or nickel. The preferred sources of Al₂O₃ and Fe₂O₃ include soluble salts, hydroxides, and/or oxides of aluminum and/or iron. The preferred sources of alkali metals (Na+K) are salts, oxides and/or hydroxides of potassium and/or sodium.

Preparations of the crystallization gel or mixture does not require a preferred ordering in the addition of the reactants. The crystallization can be carried out at either static or stirred conditions in a suitable reactor vessel such as, for example, stainless steel autoclaves. The total useful range of temperatures required for crystallization is from about 60° C. to about 200° C. for a period of time sufficient to complete crystallization at the given temperature, for instance, from about 6 hours to about 30 days. The crystallization is carried out preferably at autogenous pressure. After crystallization occurs, the crystals are separated from the mother liquor, washed with water and dried.

It should be apparent that the reaction mixture components can be supplied from more than one source, and the crystal size and crystallization time of the new crystalline material can be varied with the nature of the reaction mixture and the crystallization conditions employed.

The crystalline materials of the present invention and their preparation method will be better understood by reference to the following examples.

### EXAMPLES 1-9

The following examples were conducted to obtain different compositions of the crystalline material IPZ-D. In these experiments were used the following reactants: Sodium silicate (28.8 Wt. % SiO₂, 8.9 wt % Na₂O, 62.3 wt % H₂O), iron nitrate, aluminum hydroxide, zinc nitrate, potassium hydroxide, tetramethylammonium chloride and distilled water. The salts were dissolved in the distilled water and mixed with the sodium silicate. There is no preferred order of mixture for this synthesis. The mixture is stirred to produce a uniform fluid gel having the molar compositions shown in Table 3.

TABLE 3
MIXTURE COMPOSITION (MOLE RATIOS)

| Sample | Al₂O₃/SiO₂ | Fe₂O₃/SiO₂ | ZnO/SiO₂ | NiO/SiO₂ | (Na + K)₂O/SiO₂ | TMA/SiO₂ | H₂O/SiO₂ |
|---|---|---|---|---|---|---|---|
| 1 | 0.0723 | 0.0035 | 0.0000 | 0.0000 | 0.3878 | 0.0000 | 12.934 |
| 2 | 0.0823 | 0.0063 | 0.0000 | 0.0000 | 0.4175 | 0.0000 | 14.186 |
| 3 | 0.0947 | 0.0039 | 0.0000 | 0.0000 | 0.4370 | 0.1268 | 14.820 |
| 4 | 0.0900 | 0.0079 | 0.0000 | 0.0000 | 0.4373 | 0.1262 | 14.789 |
| 5 | 0.0823 | 0.0158 | 0.0000 | 0.0000 | 0.4378 | 0.1265 | 14.861 |
| 6 | 0.0576 | 0.0395 | 0.0000 | 0.0000 | 0.4768 | 0.1270 | 14.816 |
| 7 | 0.0494 | 0.0000 | 0.0429 | 0.0000 | 0.4421 | 0.1153 | 14.800 |
| 8 | 0.0812 | 0.0040 | 0.0000 | 0.0012 | 0.4259 | 0.1134 | 13.523 |
| 9 | 0.0823 | 0.0000 | 0.0000 | 0.0000 | 0.4345 | 0.1267 | 14.823 |

The mixture of each sample was transferred into a 2-liter stainless steel autoclave equipped with a stirrer. The autoclave was capped and sealed, and stirring and heating were started. Crystallization for each sample was carried out under the conditions shown in Table 4 at autogenous pressure.

TABLE 4
CRYSTALLIZATION CONDITIONS AND PRODUCT TYPE

| Sample | Time(h) | Temperature(° C.) | Stirring | Product Type |
|---|---|---|---|---|
| 1 | 52 | 150 | Yes | OFF |
| 2 | 36 | 160 | Yes | OFF + PHI |
| 3 | 36 | 160 | Yes | OFF |
| 4 | 38 | 160 | Yes | OFF |
| 5 | 40 | 160 | Yes | OFF |
| 6 | 62 | 160 | Yes | OFF |
| 7 | 44 | 160 | Yes | OFF |
| 8 | 52 | 150 | Yes | OFF |
| 9 | 36 | 160 | Yes | OFF |

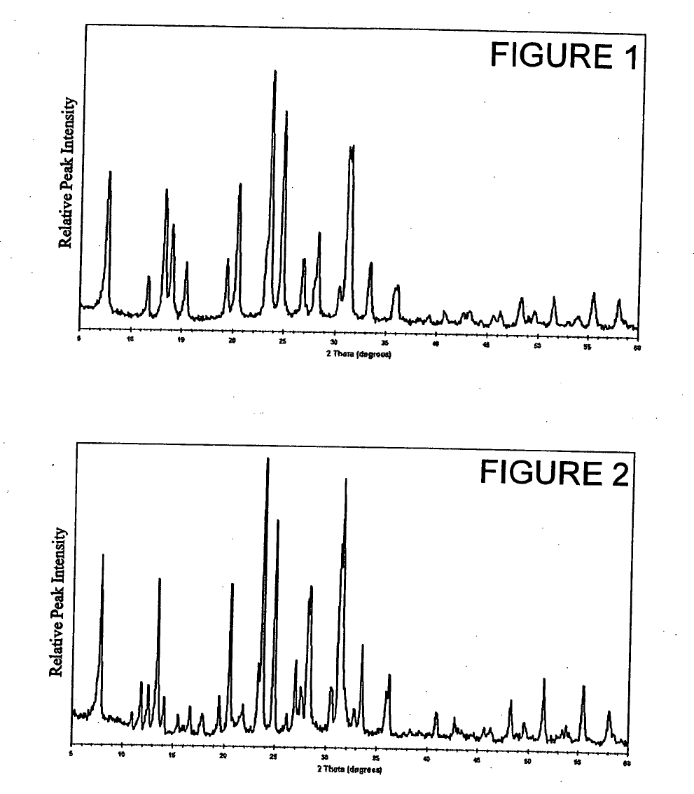

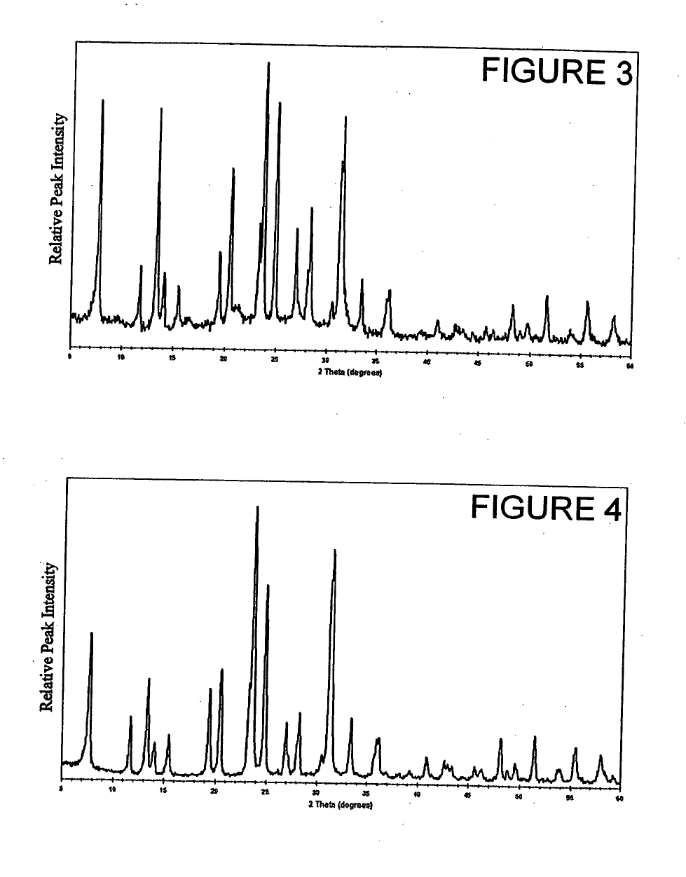

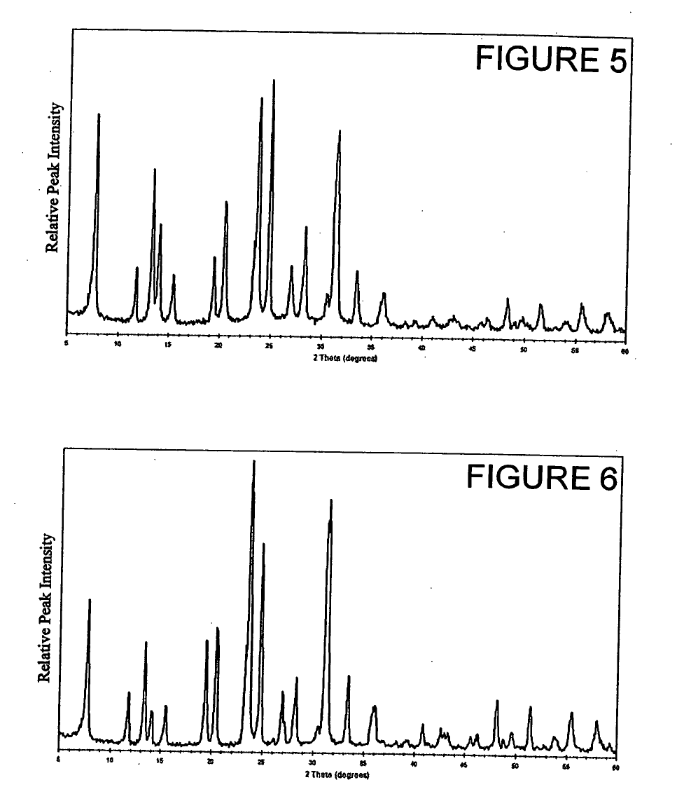

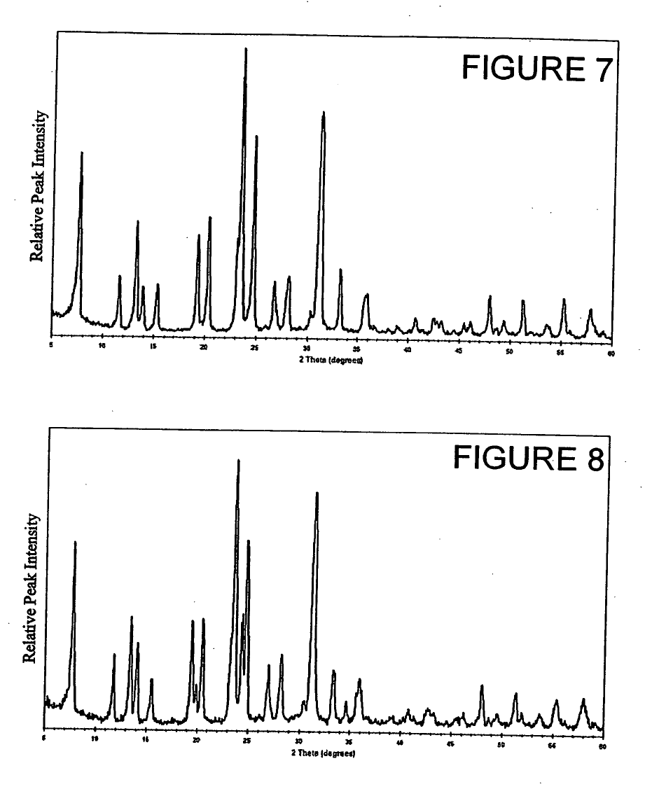

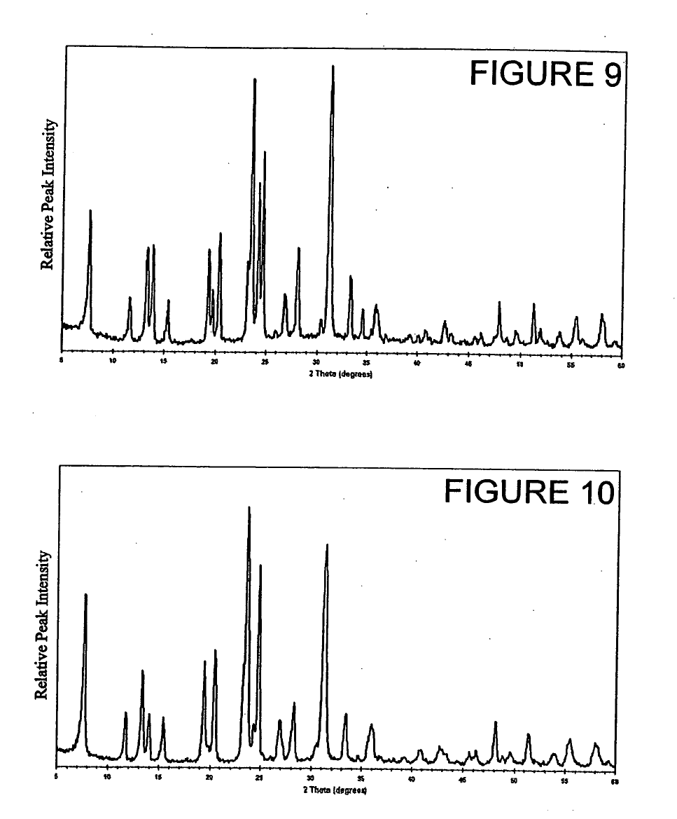

Crystalline products were filtered, washed with distilled water, and dried in an oven at 120° C. for 12 hours. Samples of the dried crystalline product for each sample in which TMA⁺ ions were used were calcined in a furnace with air at 500° C. for 6 hours. The X-ray diffraction pattern of the as-synthesized material of sample 1 is shown in FIG. 1. The X-ray diffraction pattern of the as-synthesized material of sample 2 is shown in FIG. 2. The X-ray diffraction pattern sample 2 material after ion exchange with NH4⁺ ions and calcining at 550° C. is shown in FIG. 3. The X-ray diffraction pattern of the sample 3 material after calcining at 500° C., ion exchange with NH4⁺ ions and calcining again at 550° C., is shown in FIG. 5. The X-ray diffraction patterns of the as-synthesized materials of samples 4 to 8 are shown in the FIGS. 6 to 10 respectively.

Table 5 shows the chemical formula expressed as mole ratio of oxides on an anhydrous basis for the as-synthesized materials of Samples 1 to 9. Table 6 shows comparison between the bulk chemical analysis of iron for samples 3, 4 and 5 and the XPS superficial chemical analysis for iron of the same materials. As can be seen in this comparison, the superficial amount of iron in these materials is almost a half of the amount of bulk iron, that is, iron in the framework of the material. This indicates that the present synthesis methodology allows preferential placement of iron inside the crystals and not superficially. This provides advantages in the use of the crystalline compositions as catalyst.

TABLE 5

| Sample | Chemical formula of the as-synthesized material IPZ-D |
|---|---|
| 1 | 0.149(Na + K)₂O:SiO₂:0.142Al₂O₃:0.006Fe₂O₃ |
| 2 | 0.148(Na + K)₂O:SiO₂:0.131Al₂O₃:0.018Fe₂O₃ |
| 3 | 0.101(Na + K)₂O:0.044TMA₂O:SiO₂:0.139Al₂O₃:0.007Fe₂O₃ |
| 4 | 0.104(Na + K)₂O:0.050TMA₂O:SiO₂:0.138Al₂O₃:0.016Fe₂O₃ |
| 5 | 0.112(Na + K)₂O:0.037TMA₂O:SiO₂:0.118Al₂O₃:0.032Fe₂O₃ |
| 6 | 0.101(Na + K)₂O:0.023TMA₂O:SiO₂:0.074Al₂O₃:0.051Fe₂O₃ |
| 7 | 0.147(Na + K)₂O:0.061TMA₂O:SiO₂:0.067Al₂O₃:0.075ZnO |
| 8 | 0.124(Na + K)₂O:0.051TMA₂O:SiO₂:0.135Al₂O₃:0.008Fe₂O₃:0.017NiO |
| 9 | 0.119(Na + K)₂O:0.030TMA₂O:SiO₂:0.150Al₂O₃ |

TABLE 6

| | Bulk C. | XPS C. | Bulk | XPS |
|---|---|---|---|---|
| Sample | analysis | analysis | Fe₂O₃/SiO₂ | Fe₂O₃/SiO₂ |
| 3 | 0.80 wt % Fe | 0.46 wt % Fe | 0.007 | 0.003 |
| 4 | 1.81 wt % Fe | 0.80 wt % Fe | 0.016 | 0.006 |
| 5 | 3.48 wt % Fe | 1.61 wt % Fe | 0.032 | 0.011 |

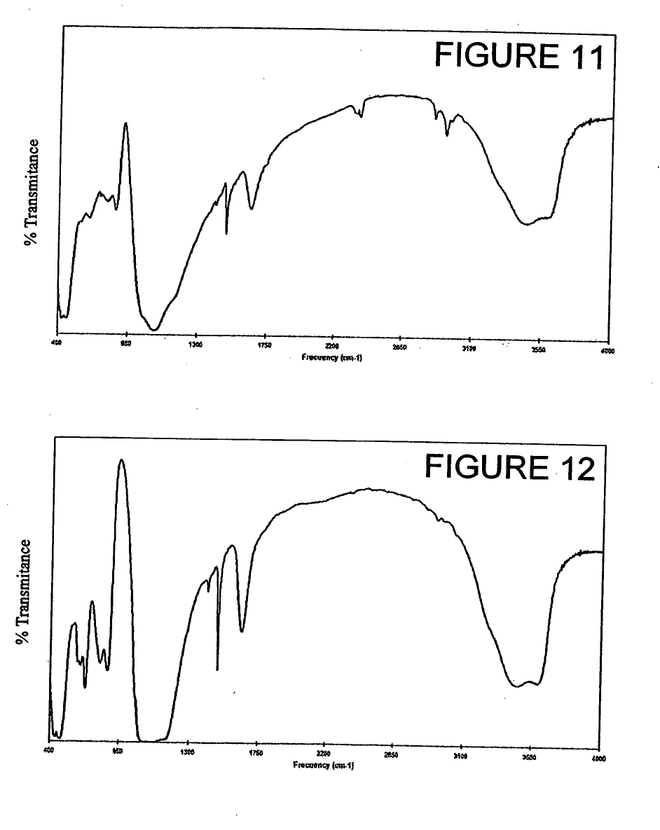

FIGS. 11 and 12 show infrared spectrums of as-synthesized samples 6 and 9, respectively. As can be seen in these figures, the incorporation of iron into the framework to generate the ferrialminuosilicate materials of the present invention produces modifications of the infrared bands when they are compared with a simple aluminosilicate material.

It should be clear that the above description and examples are given to illustrate the invention and methods of making the invention, but these examples should not be taken as limiting the scope of the invention to the particular embodiments or parameters demonstrated since obvious modifications of the teachings will be apparent to those skilled in the art.

What is claimed is:

1. An offretite metalloalluminosilicate composition, comprising an aluminosilicate framework containing at least one metal selected from the group consisting of iron, divalent elements and combinations thereof, wherein at least a portion of said metal is incorporated into said framework, and wherein said portion is at least about 0.5% wt. with respect to said composition.

2. The composition of claim 1, wherein said portion is not ion exchangeable.

3. The composition of claim 1, wherein said divalent material is selected from the group consisting of zinc, nickel and combinations thereof.

4. The composition of claim 1, wherein the composition has an X-ray diffraction pattern substantially as set forth below:

| Interplanar d-Spacing (Å) | Relative Intensity |
|---|---|
| 11.44 ± 0.40 | S |
| 7.54 ± 0.10 | W |
| 6.61 ± 0.10 | M |
| 6.30 ± 0.10 | W |
| 5.73 ± 0.08 | VW |
| 4.56 ± 0.08 | VW |
| 4.33 ± 0.08 | M |
| 3.83 ± 0.08 | W |
| 3.76 ± 0.06 | VS |
| 3.58 ± 0.06 | S |
| 3.41 ± 0.06 | VW |
| 3.31 ± 0.06 | W |
| 3.15 ± 0.06 | M |
| 2.93 ± 0.05 | VW |
| 2.85 ± 0.05 | VS |
| 2.68 ± 0.05 | W |
| 2.48 ± 0.05 | VW |
| 2.35 ± 0.05 | VW |
| 2.29 ± 0.05 | VW |
| 2.21 ± 0.05 | VW |
| 2.12 ± 0.05 | VW |
| 1.98 ± 0.03 | VW |
| 1.96 ± 0.03 | VW |
| 1.89 ± 0.03 | VW |
| 1.86 ± 0.03 | VW |
| 1.83 ± 0.03 | VW |
| 1.77 ± 0.02 | VW |
| 1.69 ± 0.02 | VW |
| 1.66 ± 0.02 | VW |
| 1.58 ± 0.02 | VW |

wherein VS = very strong, S = strong, M = middle, W = weak, and VW = very weak.

5. The composition of claim 1, wherein said composition exhibits absorption bands in an infrared spectrum.

6. The composition of claim 1, wherein the composition has a molar relationship as follows:
SiO_{2l :m Al}₂O₃:n Fe₂O₃:o ZO, wherein
Z is the divalent element;
m is between about 0.02 and about 0.5
n is between 0 and about 0.5
o is between 0 and about 0.5; and
n+o>0.

7. The composition of claim 6, wherein m is between about 0.05 and about 0.5.

8. The composition of claim 1, wherein the composition is ion exchanged to include at least one of metal ions, hydrogen ions, hydrogen precursor ions and combinations thereof.

9. The composition of claim 1, wherein said portion comprises a majority of said metal.

10. A method for making an offretite metalloaluminosilicate composition, comprising the steps of:
providing a reaction mixture comprising a source of silica, a source of alkali ions, a source of alumina, and a source of metal selected from the group consisting of iron, divalent elements and mixtures thereof; and
crystallizing said mixture so as to provide a metalloaluminosilicate framework composition having offretite topography and containing said metal wherein a portion of said metal is in said framework, and said portion is at least about 0.5% wt based on weight of said composition.

11. The method of claim 10, wherein said divalent element is selected from the group consisting of zinc, nickel and combinations thereof.

12. The method of claim 11, wherein said portion is not ion exchangeable.

13. The method of claim 11, wherein said composition has an X-ray diffraction pattern substantially as set forth below:

| Interplanar d-Spacing (Å) | Relative Intensity |
|---|---|
| 11.44 ± 0.40 | S |
| 7.54 ± 0.10 | W |
| 6.61 ± 0.10 | M |
| 6.30 ± 0.10 | W |
| 5.73 ± 0.08 | VW |
| 4.56 ± 0.08 | VW |
| 4.33 ± 0.08 | M |
| 3.83 ± 0.08 | W |
| 3.76 ± 0.06 | VS |
| 3.58 ± 0.06 | S |
| 3.41 ± 0.06 | VW |
| 3.31 ± 0.06 | W |
| 3.15 ± 0.06 | M |
| 2.93 ± 0.05 | VW |
| 2.85 ± 0.05 | VS |
| 2.68 ± 0.05 | W |
| 2.48 ± 0.05 | VW |
| 2.35 ± 0.05 | VW |
| 2.29 ± 0.05 | VW |
| 2.21 ± 0.05 | VW |
| 2.12 ± 0.05 | VW |
| 1.98 ± 0.03 | VW |
| 1.96 ± 0.03 | VW |
| 1.89 ± 0.03 | VW |
| 1.86 ± 0.03 | VW |
| 1.83 ± 0.03 | VW |
| 1.77 ± 0.02 | VW |
| 1.69 ± 0.02 | VW |
| 1.66 ± 0.02 | VW |
| 1.58 ± 0.02 | VW |

wherein VS = very strong, S = strong, M = middle, W = weak, and VW = very weak.

14. The method of claim 11, wherein said reaction mixture further comprises a source of a templating agent, and wherein said composition has a chemical formula on an anhydrous basis in terms of mole ratio of oxides as follows:
a (K+Na)₂O:b R₂O:SiO_{2:m Al}₂O₃:n Fe₂O₃:o ZO
wherein:
r is an organic moiety of said templating agent;
a is between 0.01 and 0.2;
b is between 0 and 0.15;
m is between 0.2 and 0.5;
n is between 0 and 0.5;
o is between 0 and 0.5; and
n+o>0.

15. A process for catalytically converting an organic compound, comprising the steps of:
providing an organic compound;
providing an offretite metalloalluminosilicate composition comprising an aluminosilicate framework containing at least one metal selected from the group consisting of iron, divalent elements and combinations thereof, wherein at least a portion of said metal is incorporated into said framework, and wherein said portion is at least about 0.5% wt. with respect to said composition;
contacting said organic compound and said composition at conversion conditions so as to convert said product.

16. The process of claim 15, wherein said organic compound is a hydrocarbon.

17. The process of claim 15, wherein said conversion conditions comprise fluid catalytic conversion (FCC) conditions.
